(19) United States
(12) Patent Application Publication
(10) Pub. No.: US 2021/0090326 A1
(43) Pub. Date: Mar. 25, 2021

(54) MODELING METHOD FOR ASPHALT MIXTURE BY COUPLING DISCRETE ELEMENT METHOD AND FINITE DIFFERENCE METHOD

(71) Applicant: CHANGSHA UNIVERSITY OF SCIENCE AND TECHNOLOGY, Changsha (CN)

(72) Inventors: Huanan YU, Changsha (CN); Shunjun LI, Changsha, Hunan (CN); Guoping QIAN, Changsha, Hunan (CN); Xiangbing GONG, Changsha, Hunan (CN); Xuan ZHU, Changsha, Hunan (CN)

(73) Assignee: CHANGSHA UNIVERSITY OF SCIENCE AND TECHNOLOGY, Changsha (CN)

(21) Appl. No.: 16/862,878

(22) Filed: Apr. 30, 2020

(30) Foreign Application Priority Data
Sep. 19, 2019 (CN) 201910884357.3

(51) Int. Cl. G06T 17/00

(52) U.S. Cl. CPC G06T 17/00

(57) ABSTRACT

A modeling method for an asphalt mixture by coupling a discrete element method (DEM) and a finite difference method (FDM). Aggregates of an asphalt mixture are processed by a DEM, and a finite difference method is used to implement continuous medium simulation of an asphalt binder in the asphalt mixture. The influence of the coupling of the DEM and the finite difference method on mechanical properties of the asphalt mixture such as the strength and modulus are considered, to implement simulation of the deformation, shrinkage, cracking, etc. of a multiphase material in the asphalt mixture under different load. The method can accurately restore a void structure and true shapes and sizes of the aggregates and a binder in the asphalt mixture, and can characterize distribution characteristics thereof.

### BACKGROUND

1. Field of the Disclosure

The present disclosure relates to numerical simulation of an asphalt mixture, and in particular, to a method for modeling and simulation by coupling a three-dimensional discrete element method (DEM) and a finite difference method (FDM).

2. Discussion of the Background Art

At present, most of new roads in the world use asphalt concrete pavements. However, in an asphalt mixture, aggregates are discrete with uneven shapes, and an asphalt mortar material has certain continuity. As a result, it is very difficult to simulate the aggregates and asphalt mortar during numerical simulation of the asphalt mixture. In most previous studies, a DEM is used for simulated calculation of an asphalt mixture. A DEM has some advantages in simulated calculation when a contact network, void distribution, etc. of aggregates are carefully considered. However, when an asphalt binder and large dynamic deformation shall be considered, it is still difficult to use the DEM for simulated calculation. Compared with a finite element method (FEM) or other methods, an FDM has a greatest advantage of relatively strong plastic deformation analysis ability. Moreover, it can flexibly process any constitutive model without introducing element stress into a yield surface. Therefore, it is more efficient and accurate to simulate a high-temperature plastic flow of an asphalt mixture. However, the FDM can deal with only stress, strain, and displacement of the asphalt mixture at a macro level, and cannot analyze void characteristics and contact and interlock between aggregates at a micro level.

### SUMMARY

To accurately conduct three-dimensional numerical simulation of an asphalt mixture, the present disclosure proposes a method for three-dimensional modeling by coupling a discrete element method (DEM) and a finite difference method (FDM). Aggregates of an asphalt mixture are processed by a DEM, and an FDM is used to implement continuous medium simulation of an asphalt binder in the asphalt mixture. Simulation of the deformation, shrinkage, cracking, etc. of a multiphase material in the asphalt mixture under different load is implemented by considering the influence of the coupling of the DEM and the FDM on mechanical properties of the asphalt mixture such as the strength and modulus is considered, to implement.

To resolve the problem of simulation of aggregates and a binder in an asphalt mixture, the present disclosure proposes a technical solution: a method for simulating an asphalt mixture by coupling a DEM and an FDM. The method includes the following steps: (1) scanning a test specimen of an asphalt mixture by industrial computed tomography (CT), and conducting postprocessing, to obtain three-dimensional coordinates of aggregates, a binder, and a void structure of the asphalt mixture; (2) constructing a three-dimensional model of the asphalt mixture, assigning a three-dimensional DEM attribute to an aggregate shape of the mixture, and conducting continuity simulation of asphalt mortar by using a FDM; (3) considering the influence of the aggregate shape on mechanical properties of the asphalt mixture, establishing coupling between a microscopic characteristic of the aggregates of the asphalt mixture and a stress field by using a three-dimensional DEM; (4) considering the influence of the asphalt mortar on the mechanical properties of the asphalt mixture, establishing coupling between a characteristic of the asphalt mortar of the asphalt mixture and a stress field by using the FDM; (5) setting an aggregate parameter, an asphalt binder parameter, a displacement boundary, a model constraint condition, and a load condition of a calculation model; and (6) calculating the deformation and failures of the three-dimensional DEM and a continuous element of the asphalt mixture by coupling the DEM and the FDM, to implement numerical simulation and modeling of the movement and migration of the aggregates and the cracking and deformation of the asphalt mortar in the asphalt mixture.

Beneficial effects: Compared with the prior art, the modeling method for an asphalt mixture by coupling a DEM and a FDM in the present disclosure has the following advantages. (1) The present disclosure can accurately restore a void structure and true shapes and sizes of aggregates and a binder in an asphalt mixture, and can characterize distribution characteristics thereof (2) The present disclosure overcomes limitations of analysis methods respectively based on a DEM and the FDM in numerical simulation of the asphalt mixture. (3) In the present disclosure, the true shape of the aggregates can be considered, a microscopic phenomenon of the aggregates can be analyzed for further processing, and processing can be conducted based on the large macroscopic dynamic deformation and a boundary condition of a continuous medium during compaction. (4) The method proposed in the present disclosure has high accuracy.

### BRIEF DESCRIPTION OF DRAWINGS

FIG. 1 is an implementation flowchart of a modeling method for an asphalt mixture by coupling a DEM and an FDM; FIG. 2 is a flowchart of a process for establishing an information exchange boundary for coupled calculation; and

FIG. 3 is an implementation flowchart of coupled calculation for aggregates and an asphalt binder.

### DETAILED DESCRIPTION OF THE PREFERRED EMBODIMENT

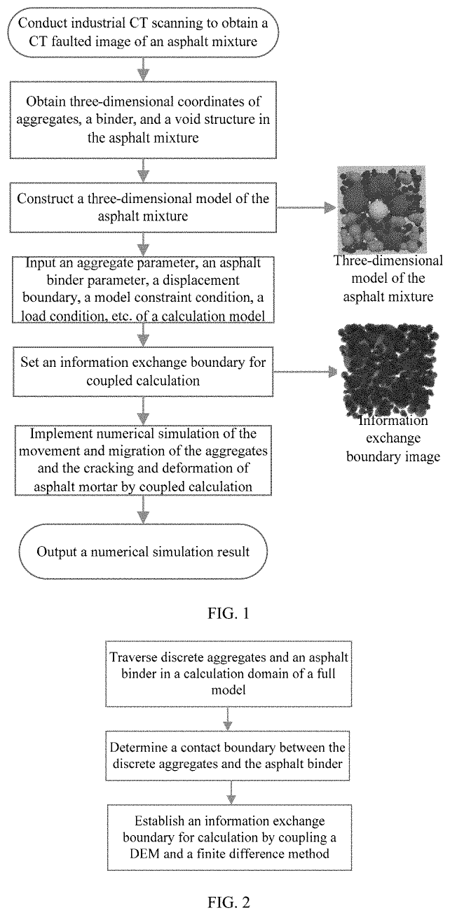

A working flowchart of a method in the present disclosure is shown in FIG. 1 to FIG. 3.

FIG. 1 is an implementation flowchart of a modeling method for an asphalt mixture by coupling a three-dimensional DEM method and an FDM.

(1) Conduct industrial CT scanning on a test specimen of an asphalt mixture to obtain a CT faulted image of the asphalt mixture.

(2) Conduct processing and three-dimensional reconstruction on the CT faulted image of the asphalt mixture to obtain three-dimensional coordinates of pixels of aggregates, a binder, and a void structure in the asphalt mixture.

(3) Construct a three-dimensional model of the asphalt mixture, establish a discontinuous aggregate model in a three-dimensional DEM, and establish a continuous model of the asphalt binder in an FDM.

(4) Input an aggregate parameter, an asphalt binder parameter, a displacement boundary, a model constraint condition, and a load condition of a calculation model.

(5) Determine a contact boundary between the aggregates and asphalt mortar, and set the contact boundary as an information exchange boundary for calculation by coupling the DEM and the FDM.

(6) Calculate the deformation and failures of the three-dimensional DEM and a continuous element of the asphalt mixture by coupling the DEM and the FDM, to implement numerical simulation of the movement and migration of the aggregates and the cracking and deformation of the asphalt mortar in the asphalt mixture.

(7) Output a numerical simulation result.

FIG. 2 is a flowchart of a process for establishing an information exchange boundary for coupled calculation. A process for establishing the information exchange boundary in step (5) is described in detail in step (21) to step (23):

(21) Traverse discrete aggregates and the asphalt binder in a calculation domain of the full model.

(22) Determine a contact boundary between the discrete aggregates and the asphalt binder.

(23) Partition space grids of a contact surface of a finite difference element on the contact boundary according to space grids of the aggregates, and set partitioned space grids as the information exchange boundary for calculation by coupling a DEM and an FDM, to implement information exchange between aggregate particles and the finite difference element.

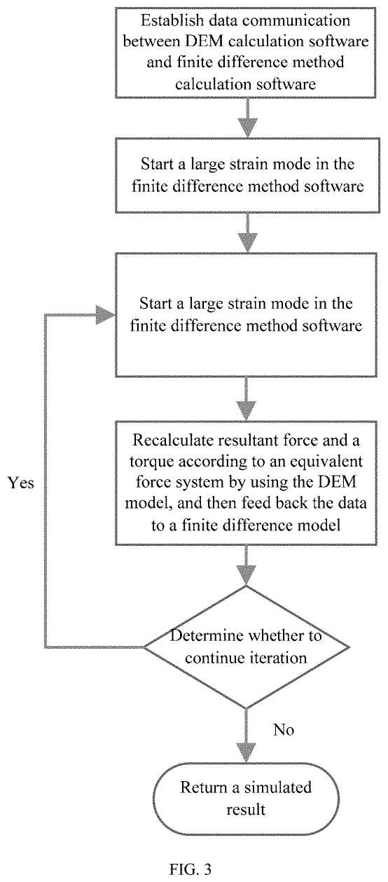

FIG. 3 is an implementation flowchart of coupled calculation for aggregates and an asphalt binder.

A process for simulation by coupled calculation in step (6) is described in detail in step (31) to step (36):

(31) Establish data communication between three-dimensional DEM calculation software and FDM calculation software according to the information exchange boundary determined in step (5).

(32) Start a large strain mode in the FDM software, to adapt to the large dynamic deformation of the asphalt binder.

(33) Calculate a cycle in an FDM by using a calculation equation, write both a speed of a boundary node and updated position coordinates thereof into an array, and send the data to a DEM model through a data interface connection.

(34) After a DEM receives the speed of the boundary node and the updated position coordinates thereof, recalculate resultant force and a torque according to an equivalent force system, and then feedback the data to a finite difference model.

(35) In each time step, determine whether to continue iteration based on a crack development status or whether a specified iteration condition is met; and if the iteration is required, proceed to step (32); or otherwise, output an iteration result.

(36) Return a simulated result.

What is claimed is:

1. A modeling method for an asphalt mixture by coupling a discrete element method (DEM) and a finite difference method (FDM), comprising the following steps:
(1) scanning a test specimen of an asphalt mixture by industrial computed tomography (CT), and conducting postprocessing, to obtain three-dimensional coordinates of aggregates, a binder, and a void structure of the asphalt mixture;
(2) constructing a three-dimensional model of the asphalt mixture, assigning a three-dimensional DEM attribute to an aggregate shape of the mixture, and conducting continuity simulation of asphalt mortar by using an FDM;
(3) considering the influence of the aggregate shape on mechanical properties of the asphalt mixture, establishing coupling between a microscopic characteristic of the aggregates of the asphalt mixture and a stress field by using a three-dimensional DEM;
(4) considering the influence of the asphalt mortar on the mechanical properties of the asphalt mixture, establishing coupling between a characteristic of the asphalt mortar of the asphalt mixture and a stress field by using the FDM;
(5) setting an aggregate parameter, an asphalt binder parameter, a displacement boundary, a model constraint condition, and a load condition of a calculation model; and
(6) calculating deformation and failures of the three-dimensional DEM and a continuous element of the asphalt mixture by coupling the DEM and the FDM, to implement numerical simulation and modeling of the movement and migration of the aggregates and the cracking and deformation of the asphalt mortar in the asphalt mixture.

2. The modeling method for an asphalt mixture by coupling a DEM and an FDM according to claim 1, comprising the following specific steps:
(1) conducting industrial CT scanning on the test specimen of the asphalt mixture to obtain a CT faulted image of the asphalt mixture;
(2) conducting processing and three-dimensional reconstruction on the CT faulted image of the asphalt mixture to obtain three-dimensional coordinates of the aggregates, the binder, and the void structure of the asphalt mixture in the CT faulted image;
(3) constructing the three-dimensional model of the asphalt mixture, establishing a discontinuous aggregate model in the three-dimensional DEM, and establishing a continuous model of the asphalt binder in the FDM;
(4) inputting the aggregate parameter, the asphalt binder parameter, the displacement boundary, the model constraint condition, and the load condition of the calculation model;
(5) determining a contact boundary between the aggregates and the asphalt mortar, and setting the contact boundary as an information exchange boundary for calculation by coupling the DEM and the FDM;
(6) calculating the deformation and failures of the three-dimensional DEM and the continuous element of the asphalt mixture by coupling the DEM and the FDM, to implement numerical simulation of the movement and migration of the aggregates and the cracking and deformation of the asphalt mortar in the asphalt mixture; and
(7) outputting a numerical simulation result.

3. The modeling method for an asphalt mixture by coupling a DEM and a FDM according to claim 2, wherein a process for establishing the information exchange boundary in step (5) is described in detail in step (21) to step (23):
(21) traversing discrete aggregates and the asphalt binder in a calculation domain of the full model;
(22) determining a contact boundary between the discrete aggregates and the asphalt binder; and
(23) partitioning space grids of a contact surface of a finite difference element on the contact boundary according to space grids of the aggregates, and setting partitioned space grids as the information exchange boundary for calculation by coupling the DEM and the FDM, to implement information exchange between aggregate particles and the finite difference element.

4. The modeling method for an asphalt mixture by coupling a DEM and a FDM according to claim 2, wherein a process for simulation by coupled calculation in step (6) is described in detail in step (31) to step (36):
(31) establishing data communication between three-dimensional DEM calculation software and FDM calculation software according to the information exchange boundary determined in step (5);
(32) starting a large strain mode in the FDM software, to adapt to the large dynamic deformation of the asphalt binder;
(33) calculating a cycle in the FDM by using a calculation equation, writing both a speed of a boundary node and updated position coordinates thereof into an array, and sending the data to a DEM model through a data interface connection;
(34) after the DEM receives the speed of the boundary node and the updated position coordinates thereof, recalculating resultant force and a torque according to an equivalent force system, and then feeding back the data to a finite difference model;
(35) in each time step, determining whether to continue iteration based on a crack development status or whether a specified iteration condition is met; and if the iteration is required, proceeding to step (32); or otherwise, outputting an iteration result; and
(36) returning a simulated result.
